(19) United States
(12) Patent Application Publication
(10) Pub. No.: US 2005/0206902 A1
(43) Pub. Date: Sep. 22, 2005

(54) Device, system and method for measuring the dilaton particle

(75) Inventor: George A. Soli, Vancouver, WA (US)

Correspondence Address: CHRISTIE, PARKER & HALE, LLP, PO BOX 7068, PASADENA, CA, 91109-7068, US

(73) Assignee: Integrated Detector Systems, LLC

(21) Appl. No.: 11/125,544

(22) Filed: May 9, 2005

Related U.S. Application Data
(63) Continuation of application No. 10/682,634, filed on Oct. 8, 2003.
Application No. 10/682,634 is a continuation-in-part of application No. 09/863,778, filed on May 23, 2001.

(51) Int. Cl. G02B 21/00

(52) U.S. Cl. 356/432; 356/256

(57) ABSTRACT

A device, system and method for measuring the sidereal or one-way “superluminal” photon group velocity is presented, in which the measurement of said “superluminal” photon group velocity may be used as a research and educational tool to explore astronomical and physical quantities as well as the dilaton fundamental particle.

### CROSS-REFERENCE TO RELATED APPLICATIONS

This application is a continuation of U.S. patent application Ser. No. 10/682,634, filed, Oct. 8, 2003, which is a continuation-in-part of U.S. patent application Ser. No. 09/863,778, filed May 23, 2001, the contents of which are incorporated herein by reference.

### FIELD OF THE INVENTION

The present invention is directed to a device, system and method for measuring the dilaton fundamental particle.

### BACKGROUND OF THE INVENTION

Several groups studying the phenomena of tunneling have shown that the group-velocity, of photons tunneling through a barrier, is “superluminal”. For example, “superluminal” group velocity can be measured as the time that photon energy is stored in a barrier that a photon tunnels through. To summarize, the classical electromagnetic superluminal energy pulse cannot get past its luminal wavefront and is superluminal only inside the wavepacket as described by Chiao (R. Y. Chiao, “Tunneling Times and Superluminality: a Tutorial”, arXiv:quant-ph/9811019, 7 Nov. 1998, the disclosure of which is incorporated herein by reference). As such, “superluminal” group velocities of light are one-way or sidereal group velocities, and do not exist near the wavefront as previously described in U.S. application Ser. No. 09/863,778, and as described by Will (C. Will, “Clock synchronization and isotropy of the one-way speed of light”, Phys. Rev. D 45, 403 (1992)), the disclosure of which is also incorporated herein by reference.

In a measurement of the one-way group velocity of light, the tunneling photon-wavepacket group-peak arrives at the input to the barrier at time t=0 ns and exits the barrier at time t=6.0 ns. But the barrier is 190 cm long, and traveling at the vacuum speed of light, the wavepacket group would take 6.3 ns to traverse a distance of 190 cm. However, the wavepacket has a length of 80 ns times the vacuum speed of light and wavepacket wavefronts always travel at the vacuum speed of light, even in materials. Therefore, one practiced in the art of “superluminal” tunneling would say that photon energy is stored in the barrier for 0.3 ns less than the time it takes light to travel across the barrier, or that the measured group-delay time is a negative 0.3 ns. A detailed discussion of these types of “superluminal” tunneling experiments are provided by R. Y. Chiao, “Tunneling Times and Superluminality: a Tutorial” (arXiv:quant-ph/9811019, 7 Nov. 1998).

Measurements of the Rembielinski one-way “superluminal” group velocity of light are valuable from a scientific perspective because such measurements open pathways for measuring a number of fundamental physical quantities. For a more detailed discussion of the Rembielinski one-way “superluminal” group velocity see, e.g., J. Rembielinski, “Superluminal Phenomena and the Quantum Preferred Frame” (quant-ph/0010026, 6 Oct. 2000). For example, measurement of the group velocity of light would allow one to probe astronomical values, such as the cosmic microwave background Doppler redshift direction and the amount of dark energy density required to cause the known acceleration in the expansion rate of the universe. A superluminal group-velocity detector would also allow for the measurement of values associated with particle physics, such as the inverse fine structure constant and the detection of the dilaton.

Despite this theoretical knowledge of wavefront and group velocities of light, and the significant interest in obtaining measurements of this value, previous attempts to measure these quantities by several groups have either failed or indicated that they are non-existent. For a more detailed discussion of previous attempts to measure the one-way wavefront velocity of light see, e.g., C. Will, “Clock synchronization and isotropy of the one-way speed of light” (Phys. Rev. D 45, 403 (1992)).

The reason for these previous failures lies in the high time sensitivity requirements and general state of the art in detector technology. For example, one theoretical “superluminal” velocity apparatus was designed at U.C. Berkeley (UCB) and requires a detector with a time sensitivity of 2.7 attoseconds to measure the Rembielinski one-way “superluminal” group velocity of light (β(CRF)×Δτ=2.7 attoseconds). Such a measurement is far beyond the time resolution of even the most sensitive precision instruments.

Accordingly, a need exists for an improved detector capable of determining the one-way group velocity of light and making related astronomical and physical measurements.

### SUMMARY OF THE INVENTION

The present invention is directed to a device, system and method for measuring a sidereal or one-way “superluminal” photon group velocity. The sidereal photon phase velocity can then be used as an educational and research tool to measure other astronomical and physical constants, and to serve as a dilaton particle detector.

In one embodiment of the invention the sidereal photon phase velocity is used to track the RG (Renormalization Group) flow that is parameterized by the inverse fine structure constant. In such an embodiment the sidereal subluminal phase velocity parameterized by the bandlimit time is observed to flow with the RG to the inverse fine structure constant as the cosmic compass swings through the cosmic microwave background Doppler redshift direction.

In another embodiment, the invention is used as an indicator for the s-duality and dilaton physics. In such an embodiment, the cosmic compass technology is utilized to measure the inverse fine structure constant, which is the particle physics proof of the dilaton existence.

In still another embodiment, the invention may be used to detect dilaton microscopic “wormholes”. In such an embodiment, the invention may also be used to measure the dilaton negative energy density of the excited “phantom” dark energy that is required to support dilaton “wormholes.”

In yet another embodiment, the invention may be used to determine what causes of the accelerated expansion rate of the Universe.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic view of an embodiment of the sidereal or one-way “superluminal” photon group velocity measurement device according to the invention.

FIG. 2 is a graphical representation of the L/c free photon time and the data tunneling time calibration of one embodiment of the measurement apparatus of the current invention.

FIG. 3 is a graphical representation of the conservation of energy properties of one embodiment of the measurement apparatus of the current invention.

FIG. 4 is a graphical representation of the TDC spectrum properties of one embodiment of the measurement apparatus of the current invention.

FIG. 5 is a graphical representation of the band limit properties of one embodiment of the measurement apparatus of the current invention showing a measurement of the inverse fine structure constant.

FIG. 6 is a graphical representation of the Peaking time sidereal oscillation minimums and the computed redshift direction standard and daylight times as measured by one embodiment of the measurement apparatus of the current invention.

FIG. 7 is a schematic representation of the RG flow from near the boundary CFT₄ to the bulk AdS₅ caustic using one embodiment of the measurement apparatus of the current invention.

FIG. 8 is a graphical representation showing the photon phase velocity (bandlimit time) flow with the RG to the caustic at the inverse fine structure constant (gₜₜ=137.036) using one embodiment of the measurement apparatus of the current invention.

FIG. 9 is a graphical representation of measured peaking time minimum at the computed redshift time where the amplitude of the sidereal oscillation is about 0.2 ns one embodiment of the measurement apparatus of the current invention.

### DETAILED DESCRIPTION OF THE INVENTION

The present invention is directed to a device, system and method for measuring a sidereal or one-way “superluminal” photon group velocity, referred to herein as a “cosmic compass.” The sidereal photon phase velocity can then be used as an educational and research tool to measure other astronomical and physical constants, such as for measuring excited dark energy and therefore causing the experimental discovery of the dilaton fundamental particle.

The apparatus of the current invention differs from previous “superluminal” tunneling apparatus in that it was designed specifically to measure the one-way group velocity of light. The one-way photon wavefront velocity of light has been measured by several groups and found to be non-existent. The reason for these previous failures lies in the nature of the measurement. For example, the Cosmic Rest Frame (CRF) has a velocity, averaged over a year, relative to the Earth, that is β(CRF)=0.001237±0.000002, and is a vector that points in the direction with a right ascension of 23.20 h and a declination of 7.22°, i.e., the cosmic microwave background Doppler redshift direction. The CRF is the inertial reference frame in which the cosmic microwave background temperature is isotropic. (For a more detailed discussion of the cosmic microwave background temperature see, K. Hagiwara et. al., Phys Rev D 66, 010001 (2002); and D. Fixsen et. al., Astrophys. J. 473, 576 (1996).) Accordingly, for any apparatus to detect and measure the one-way “superluminal” group velocity of light the apparatus must be rotated through this direction. The time that energy is stored in the tunneling barrier, or tunnel time, times β(CRF), equals the expected required time sensitivity of the analyzer for measuring the Rembielinski one-way “superluminal” group velocity of light. The current invention recognizes that for an apparatus to have sufficient sensitivity to measure the one-way “superluminal” group velocity of light, i.e., the time that energy is stored in the tunneling barrier, it must use photons having wavelengths much longer than those contemplated by previous devices.

For example, Table 1, below, compares the cosmic compass apparatus of the current invention to the Berkeley (UCB) “superluminal” apparatus, previously discussed.

TABLE 1
Comparison of Cosmic Compass and UCB Devices

| | | |
|---|---|---|
| | | COSMIC |
| Apparatus | UCB | COMPASS |

| | | | | |
|---|---|---|---|---|
| Wavelength | 700 | nm | 2000 | mm |
| Bandwidth (wavelength) | 6 | nm | 90 | mm^{a} |
| | | | 60 | mm^{b} |
| Bandwidth (time) | 0.02 | fs | 0.3 | ns^{a} |
| | | | 0.2 | ns^{b} |
| Sidereal oscillation time | 0.02 | fs | 0.3 | ns^{a} |
| | | | 0.2 | ns^{b} |
| Wavepacket time width | 20 | fs | 80 | ns |
| Mirror length | 1.1 | μm | 1.9 | m |
| Negative group delay | 1.47 | fs | 0.3 | ns |
| Group delay precision | 0.21 | fs | 0.033 | ns^{a} |
| | | | 0.028 | ns^{b} |
| Tunneling time (Δτ) | 2.2 | fs | 5.97 | ns |
| β(CRF) × Δτ | 2.7 | as | 7.38 | ps |

^{a}indicates 2002 data
^{b}indicates 2003 data.

In summary, for the prior art UCB apparatus, β(CRF)×Δτ=2.7 attoseconds. A time sensitivity of 2.7 attoseconds, required for the UCB analyzer to measure the Rembielinski one-way “superluminal” group velocity of light, is far beyond current analyzer technology. In contrast the cosmic compass analyzer only requires a 7.38 ps resolution. The measured one-way “superluminal” group velocity is much larger than the Rembielinski theoretical value of ±7.38 ps over a length of 190 cm. The measured sidereal oscillation time in the cosmic compass is 0.3 ns or 0.2 ns, depending on whether 2002 or 2003 data is used, and these times are equal to the measured bandlimit time of 0.3 ns or 0.2 ns, respectively. Assuming that the UCB apparatus sidereal oscillation time would also equal its bandlimit time of 0.02 fs, then the UCB analyzer precision required to measure the sidereal oscillation is 0.02 fs, about one order of magnitude smaller than their measured analyzer precision of 0.21 fs. Therefore the UCB apparatus is not able to measure its sidereal oscillation time of 0.02 fs because it is hidden in a noise of 0.21 fs. The UCB apparatus would also have to be rotated into and out of the cosmic microwave background Doppler redshift direction to detect the sidereal oscillation time.

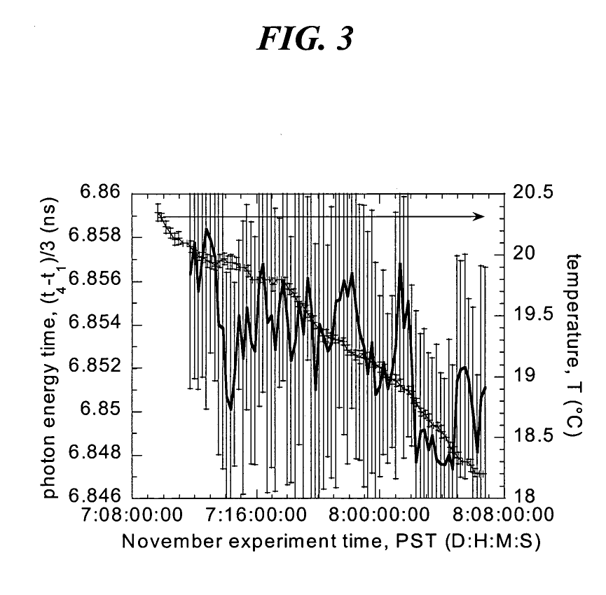

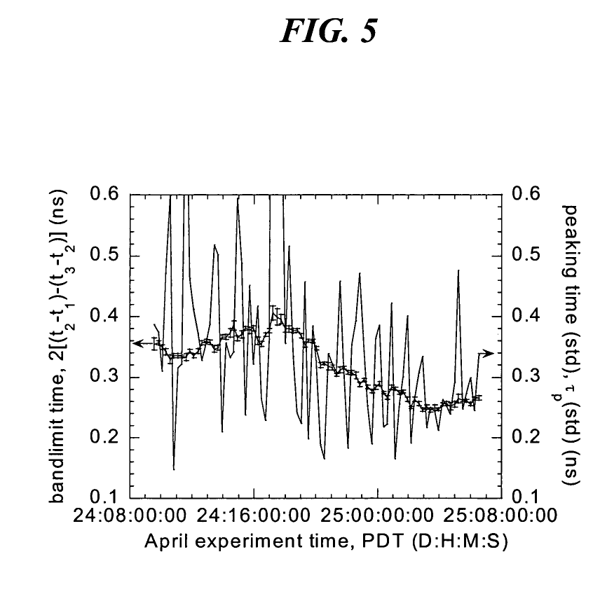

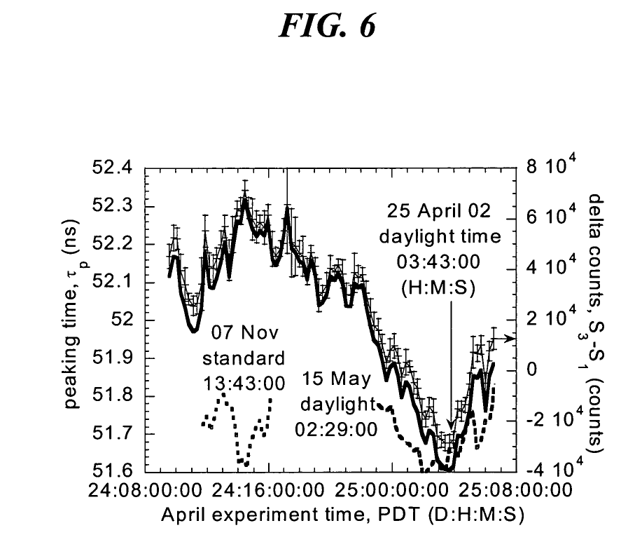

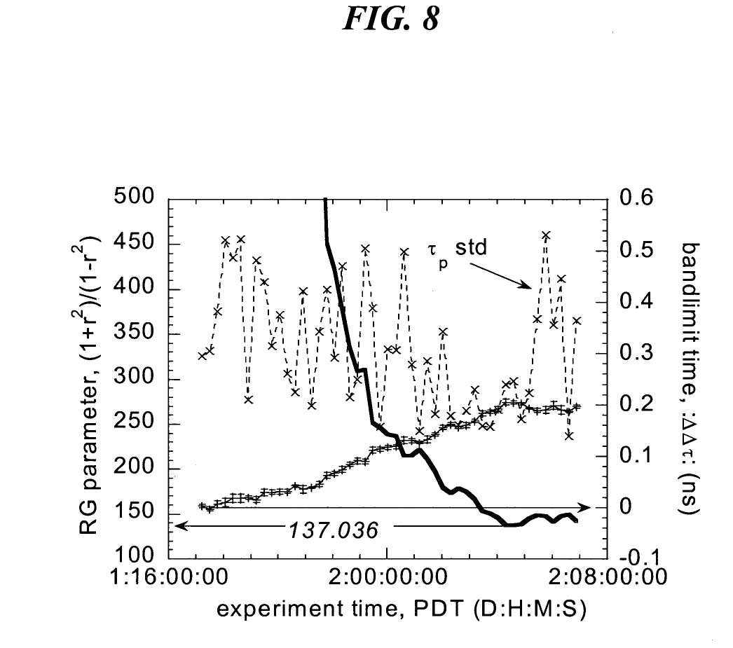

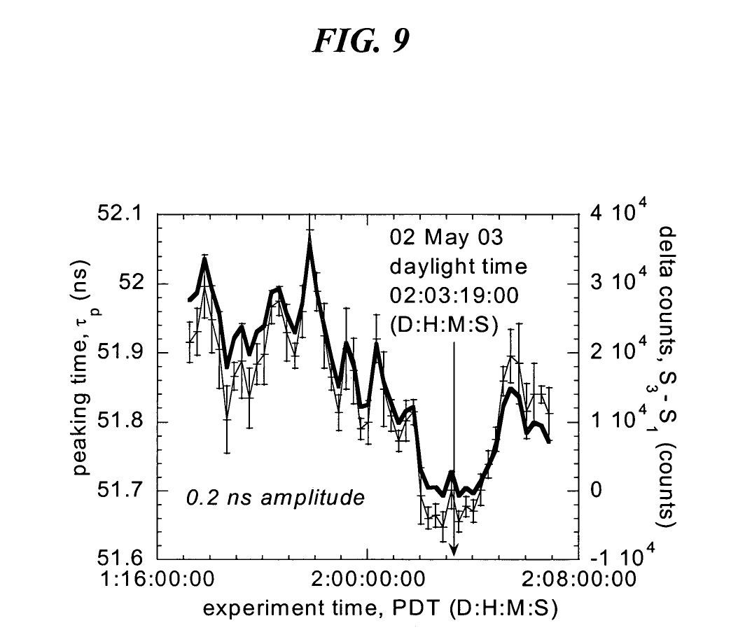

Therefore, it has been surprisingly found that an apparatus capable of measuring the one-way “superluminal” group velocity of light must use long wavelength photons. The analyzer used in the cosmic compass apparatus has a measured precision of ±7 ps in photon energy time (shown in FIG. 3 as photon energy time error bars), and ±33 ps and ±28 ps in peaking times (shown in FIGS. 6 and 9, respectively as the delta counts error bars projected onto the peaking time axis). The small error in delta counts causes the small peaking time error relative to the measured peaking time standard deviations shown in FIGS. 5 and 8. The large peaking time standard deviation is caused by a minimum lower bound defined by the bandlimit time shown in FIGS. 5 and 8. The minimum lower bound defined as the Nyquist sample spacing enables delta counts data to track the peaking time with a higher precision than the peaking time formal standard deviation. For a more detailed discussion of minimum lower bound and Nyquist sample spacing see, A. Kempf, “Fields over Unsharp Coordinates”, Phys. Rev. Lett. 85, 2873 (2000), the disclosure of which is incorporated herein by reference.

The above discussion has focussed on the measurement of the Rembielinski (±7.38 ps) and bandlimit (±33 ps and ±28 ps) one-way “superluminal” group velocities of light, that are maximum when tunneling is into the cosmic microwave background Doppler redshift direction, using the cosmic compass of the current invention. But the cosmic compass also allows for the measurement of other numbers, one provided by astronomy and one provided by particle physics. The astronomical number is a positive energy density of 6.7E-10 J/m³, i.e., the amount of dark energy density, distributed homogeneously throughout all of space, required to cause the known acceleration in the expansion rate of the universe. The particle physics number is the inverse fine structure constant, 137.036=hc/e².

In turn each of these measurements in conjunction build a physical picture of the dilaton. For example, the first astronomical proof of the dilaton's existence is the measurement of luminal energy flow through microscopic “wormholes” into the Doppler redshift direction that would otherwise appear “superluminal”. The microscopic “wormholes” exist only into the Doppler redshift direction because the measured “superluminal” group velocity is a one-way “superluminal” group velocity. Accordingly, by having the capability to determine the Doppler redshift direction, and to make measurements of the luminal energy flow in this direction, the cosmic compass is able to determine the existence of these “wormholes.” Likewise, the second astronomical proof of the dilaton's existence is the measurement of dilaton “wormhole” negative excited “phantom” dark energy density, which is directly measurable by the cosmic compass, and is distributed non-homogeneously inside the cosmic compass space of the current invention. Finally, the inverse fine structure constant number is also the dimensionless magnetic monopole charge that is associated with the concept of s-duality wherein said s-duality contains the modern string physics concept of the dilaton fundamental particle. In short, the particle physics proof of the dilaton existence is the measurement of the inverse fine structure constant.

In summary, the cosmic compass measures the inverse fine structure constant of (137±4=137.036), shown in FIG. 8, and therefore identifies the dilaton “wormhole” that causes the measured one-way “superluminal” group velocity of light while conserving photon energy as shown in FIG. 3. Dilaton microscopic “wormholes” conserve photon energy while maintaining “superluminal” group velocities. The cosmic compass measures the inverse fine structure constant, identifying the dilaton scalar particle “wormhole” as the cause of the measured sidereal one-way “superluminal” group velocity of light. For a more detailed discussion of dilaton microscopic “wormhole” physics identified by the cosmic compass apparatus see, e.g., C. Callan and J. Maldacena, “Brane Dynamics from the Born-Infeld Action”, Nuc. Phys. B 513 (1998) 198, the disclosure of which is incorporated herein by reference.

The dilaton was theoretically discovered by Theodore Kaluza in 1919 while obtaining electromagnetic fields from Einstein's equations in 5-dimensions. The dilaton appears experimentally in the cosmic compass apparatus as sidereal electromagnetic energy storage time in tunneling barriers. Measured energy storage times are minimum for energy propagation into the cosmic microwave background Doppler redshift direction. Short energy storage time is not superluminal energy flow that would violate the conservation of photon energy as described by Rembielinski, because dilaton “wormholes” transport photon energy at the vacuum speed of light, through the tunneling barrier. The measured dilaton “wormhole” consumes a Nyquist sample spacing of space in the tunneling barrier and inside the “wormhole”. For a more detailed introduction to modern dilaton physics see, e.g., M. Duff, “A Layman's Guide to M-Theory”, arXiv:hep-th/9805177 v3 2 Jul. 1998, the disclosure of which is incorporated herein by reference.

The dilaton fundamental particle measured herein is negative energy excitations of the positive “phantom” dark energy field. The measured dilaton negative energy density per photon saturates the Ford-Roman Quantum Inequalitie (QI). Accordingly, when the cosmic compass apparatus saturates the QI by completely exciting the positive “phantom” dark energy inside the cosmic compass apparatus into a negative energy density state, then the dilaton negative energy density produced by each tunneling electromagnetic pulse is equal and opposite to the positive dark energy density with negative pressure required throughout space to cause the known accelerated expansion rate of the Universe. For a more detailed introduction into dark-energy accelerated expansion physics and QI physics see, e.g., J. Cramer, ““Outlawing” Wormholes and Warp Drives”, Analog, Science Fiction and Science Fact, May 2005 and T. Roman, “Some Thoughts on Energy Conditions and Wormholes”, gr-qc/0409090 v1, 23 Sep. 2004, the disclosures of which are incorporated herein by reference.

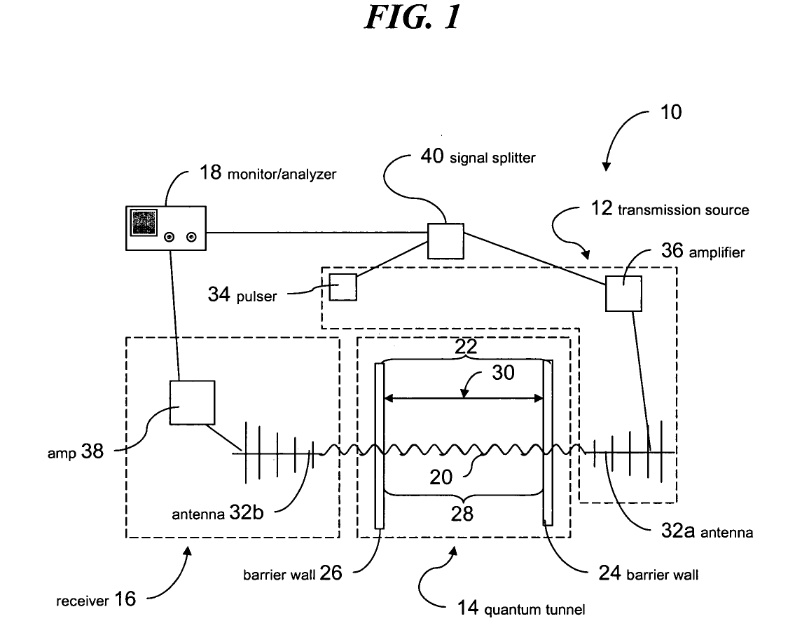

Turning now to the design of the cosmic compass, in one embodiment, as shown in FIG. 1, the cosmic compass device 10 comprises a transmission source 12, a quantum tunnel 14 adapted to receive a transmission from the transmission source 12, a receiver 16 in signal communication with the quantum tunnel 14 and a monitor 18 adapted to communicate the transmission to a user.

A transmission wavepacket 20 is introduced into the quantum tunnel 14 from the transmission source 12 such that the transmission wavepacket 20 is conducted through the space between the transmission source 12 and the receiver 16 to the monitor 18. The quantum tunnel 14 is placed in proximate relation to the transmission source 12 such that the transmission wavepacket 20 passes through the quantum tunnel 14 and the wavepacket 20 is transmitted into the receiver 16 creating a signal. A receiver or series of receivers 16, are adapted to receive the signal and transmit the signal to a monitor 18 in signal communication therewith. Any device having the ability to detect changes in amplitude, frequency, phase or wavelength of the transmission wavepacket 20 can be used as a receiver 16 and monitor 18, such as, for example, a radio amplifier in signal communication with an oscilloscope or a Time to Digital Converter (TDC). Additionally, any suitable transmission source 12 may be used in the subject invention, such as, for example, a microwave generator or a radio transmitter so long as detectable levels of electromagnetic radiation are transmitted to the receiver 16 in the form of a transmission wavepacket 20.

In general terms, the quantum tunnel 14 comprises a quantum air-gap barrier 22, such as a Bragg mirror constructed with two water tanks separated by an air-gap. The air-gap length is adjusted to the minimum Poynting vector, defining a Bragg mirror, which is in signal communication with the transmission source 12. The quantum air-gap barrier 22 comprises a proximal 24 and distal 26 barrier wall and an air-gap 28 having a tunneling, or air-gap, length 30 disposed therebetween. The proximal barrier wall 24 is in signal communication with the transmission source 12 and the distal barrier wall 26 of the air-gap barrier 22 is in signal communication with the receiver 16. The transmission wavepacket 20 from the transmission source 12 interacts with the air-gap barrier 22 which transmits the transmission wavepacket 20 across the air-gap 28 to the receiver 16 at subluminal phase velocities. The air-gap barrier 22 generates “superluminal” transmission group velocities in the wavepacket group component of the transmission wavepacket 20 across the air-gap 28. In one preferred embodiment, a radio transmission source 12, a radio receiver 16 and an air-gap barrier 22 comprising a proximal tank 24 and a distal tank 26 aligned parallel to each other across an air-gap 28 are utilized to generate the “superluminal” group velocity transmissions. The proximal tank 24 is placed in signal communication with the transmission source 12 and the distal tank 26 is placed in signal communication with the receiver 16. The tanks 24 and 26 are arranged such that an air-gap 28 is created between having an air-gap length 30. In this embodiment, the tanks 24 and 26 may have any index of refraction suitable to act as a quantum barrier such as, for example, a Plexiglas™ tank filled with water.

To transmit the transmission wavepacket 20 to and from the quantum tunnel 14, the transmission source 12 and receiver 16 must be positioned relative to quantum tunnel 14 such that the transmission wavepacket 20 passes through the quantum tunnel 14. In the embodiment shown in the attached figures, a radio transmission source 12 and a radio receiver 16 utilize antennas 32 directed at the quantum tunnel 14. However, any bandlimiting, and therefore wavepacket producing, antenna 32 design can be used such that the transmission is a wavepacket 20.

A prototype of the superluminal transmission device 10 described above was constructed. A NIM-logic pulser 34 (Phillips Scientific model 417 Nuclear Instrumentation Standard Pocket Pulser) in signal communication with an amplifier 36 (RadioShack catalog # 15-1113C) is used in the transmission source 12 and is placed in signal communication with a bandlimiting five-element folded-dipole Yagi antenna 32a designed for two-meter wavelength radio waves. A second amplifier 38 (RadioShack catalog # 15-1113C) in signal communication with a second five-element folded-dipole Yagi antenna 32b is used as the receiver 16. Both antennas 32a and 32b comprise 1/8 inch diameter aluminum ground wire reflectors and directors, and a #10 copper wire folded dipoles. 75 ohm to 300 ohm transformers, (RadioShack catalog # 15-1140), are connected to 75 ohm cables at the antennas 32a and 32b. Each antenna 32a and 32b is also surrounded by an aluminum screen (not shown), with a 114 cm wide opening along the folded-dipole direction to bandlimit the transmission wavepacket 20. The signal from the receiver amplifier 38 is fed into an oscilloscope monitor 18 (Tektronix TDS220) and a TDC monitor 18 (ORTEC 9308 Picosecond Time Analyzer preceded by a 9307 pico-Timing Discriminator). The transmission source 12 signal is also monitored by the oscilloscope and TDC monitor 18 via a signal splitter 40 which is placed in signal communication with the NIM standard logic pulser 34.

The quantum tunnel 14 comprises an air-gap barrier 22 having proximal 24 and distal 26 barrier walls arranged such that an air-gap 28 lies therebetween. The proximal 24 and distal 26 barrier walls consist of two 4 ft wide and 2 ft high distilled water tanks. The distilled water layer thickness in each tank is 12.7 mm or 0.5 inch and the index of refraction is n=9 and k=0.002. The water tanks are constructed with quarter inch thick Plexiglass having an index of refraction of n=1.6 and k=0.0.

During operation of the apparatus a pulser signal is split into two cables. The one leading directly to the Time to Digital Converter (TDC) is used to start the TDC. The other cable leads, through an amplifier, to the transmitting antenna. The transmitting and receiving antennas are identical five-element folded-dipole Yagi antennas designed for two-meter wavelength radio waves. Each antenna is surrounded by aluminum screen except for openings at the antenna ends that are 114 cm wide (along the folded dipole direction), bandlimiting the wavepacket. This opening is slightly smaller than the 122 cm or 4 feet wide water tanks. The transmitter and receiver folded-dipoles are held fixed at 4.9 meters apart.

The TDC is a 9308 Picosecond Time Analyzer preceded by a 9307 pico-Timing Discriminator (before the stop TDC input) from ORTEC™. The pulser is a battery powered Phillips Scientific™ Model 417 NIM Pocket Pulser. The transmitting and receiving amplifiers are from RadioShack™ catalog number 15-1113C. The pulser is connected through a signal splitter, catalog number 15-1234, to the input of the transmitting amplifier. 300-ohm to 75-ohm transformers, catalog number 15-1140, connect to 75-ohm cables at the antennas. The cable lengths are adjusted so that the pulser TDC start pulse arrives at the TDC just prior to the wavepacket wavefronts.

In the current invention, the one-way “superluminal” group velocity, and the average speed of energy flow of photon wavepackets is measured for two-meter wavelength photons tunneling through a water mirror. The advantage of using long wavelength photons, as opposed to the optical or short wavelength photons used in the prior art, as discussed previously, is that one is able to measure the small sidereal effects that are the one-way “superluminal” group and subluminal phase velocities of light that scale with photon wavelength. The sidereal, or one-way, “superluminal” group velocity was first predicted by Reichenbach as the relativity of simultaneity for superluminal energy flow. See, e.g., H. Reichenbach, The Direction of time, M. Reichenbach Editor, Dover Publications, Mineola N.Y. 1999, the disclosure of which is incorporated herein by reference. Changing Shannon entropy with Renormalization Group (RG) flow as described by Fujikawa (K. Fujikawa, “Remarks an Shannon's Statistical Inference and the Second Law in Quantum Statistical Mechanics”, arXiv:cond-mat/0005496 v4, 1 Apr. 2002, the disclosure of which is incorporated herein by reference), in turn causes the subluminal phase velocity to be sidereal, which in turn leads to the fine structure constant at the end of the RG flow. Because we measure the inverse fine structure constant, it in turn indicates s-duality and dilaton physics turning on.

The classical “superluminal” electromagnetic group velocity theory that is experimentally demonstrated here, and the history of superluminal group velocity measurements are described by Peatross, Glasgow, and War (full citation provided below). In this theory, the classical “superluminal” electromagnetic pulse energy arrival time only involves the Poynting vector, and is given by the time expectation integral over the incoming Poynting flux. The energy arrival time used for describing the classical electromagnetic pulses used in this experiment is defined by the time-center-of-mass as described by Peatross et. al. As such, the complex part of the index of refraction is small and the measured group delay involves only the real part of the index of refraction as described, for example, by Peatross, Glasgow, S. A. Glasgow, and M. Ware, “Average Energy Flow of Optical Pulses in Dispersive Media”, Phys. Rev. Lett. 84, 2370 (2000), the disclosure of which is incorporated herein by reference.

Accordingly, the average classical energy arrival time or time-center-of-mass of (n) voltage peaks in each wavepacket is given by,

$${τ}_{p} \pm {τ}_{p} ( std ) = {\sum }_{k = 1}^{n} {t}_{k} {S}_{k} / {\sum }_{k = 1}^{n} {S}_{k} \pm {τ}_{p} \sqrt{2 {( {\sum }_{k = 1}^{n} {s}_{k} / {\sum }_{k = 1}^{n} {S}_{k} )}^{2}} \qquad ( 1 )$$

where (τₚ) is the energy peaking time (Sₖ) is the Poynting vector of voltage peak (k), (sₖ) is the Poynting vector formal (std) standard deviation, and (tₖ) is the voltage peak's centroid computed using a Gaussian fit to a single peak (k) in the spectrum. It will be observed that the classical energy peaking time (τₚ) defines the photon group velocity. The classical energy peaking time (τₚ) is also given by a Gaussian fit to all of the (n) peaks in a spectrum (as described in the cosmic compass application).

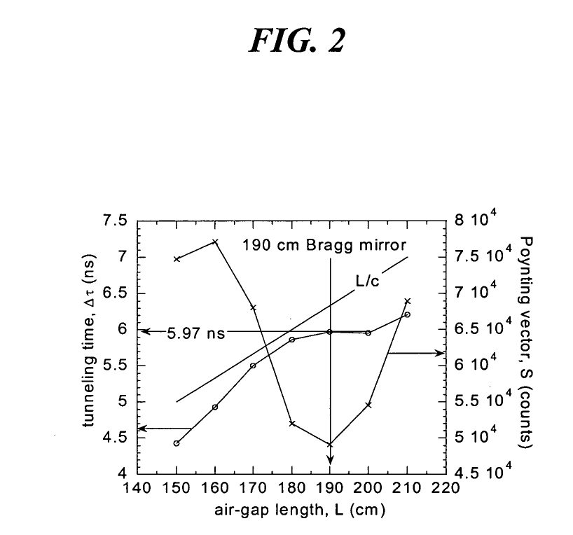

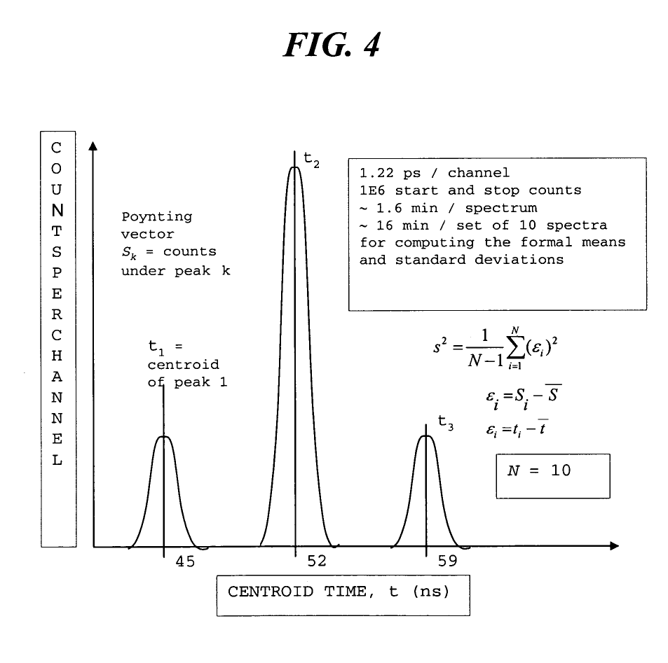

In the experiments conducted, the arrival time difference between the tunneled wavepacket and the pulser is histogrammed by the TDC. Arrival time histograms measuring the voltage peak centroid times (tₖ) and the number of counts under each peak (Sₖ) are collected in 1.6 minutes as shown in FIG. 4, and 10 histograms are used to compute the formal mean and standard deviation values shown in the data plots. The TDC has a histogramming bin width of 1.22 ps over an 80 ns window. There are 1E6 start and stop counts in each TDC spectrum, except for the calibration data shown in FIG. 2. The 9307 discriminator level is set above the noise but low enough so that every start count has a valid stop count for all data except the calibration data shown in FIG. 2. The measured peaking time difference (τ_{g}=τₚ−(τₚ)_{FREE}) is defined as the measured group delay time (τ_{g}) [1]. The measured tunneling time is (Δτ=(L/c)+τ_{g}) where, (L/c) is the free photon time that is measured with both the water tanks removed and L is the air-gap length.

For example, a measured tunneling time of 5.97 ns is shown in FIG. 2. To calibrate the detector system it is necessary to find where the tunneling time is independent of the air-gap length. This happens at the minimum in the Poynting vector at an air-gap length of 190 cm as shown in FIG. 2.

The cosmic rest frame (Cosmic Rest Frame=CRF) velocity vector is in the direction opposite the Earth's motion that causes the cosmic-microwave-background Doppler redshift. The CRF velocity is β(CRF)=0.001237±0.000002 and is a vector that points in the direction of right ascension of 23.20 h and declination of 7.22°, the cosmic microwave background Doppler redshift direction as described by Hagiwara and Fixsen.

As shown in FIG. 4, there are three peaks (n=3) in each TDC spectrum for the April and May data sets in 2002 and in all 2003 data sets and four peaks (n=4) in the November 2002 data set. The tunneling direction is parallel to the Earth's surface with an azimuth of 80° in Vancouver, Wash. Once per day the Earth's spin rotates the tunneling direction into the cosmic-microwave-background Doppler redshift direction. This direction equivalence between the photon propagation direction through the tunnel and the cosmic-microwave-background Doppler redshift direction happens once per day and the time of this equivalence is sidereal and therefore changes by about four minutes per day and moves around the clock as the Earth moves around the Sun.

For the measured tunneling time of Δτ=5.97 ns, shown in FIG. 2, and the non-relativistic velocity vector addition, the tunneling time sidereal oscillation would be Δτ=5970±7.38±0.59 ps. The ±7.38 ps is the daily sidereal oscillation caused by the Earth's spin rotating the tunneling photon propagation direction into, and out of, the cosmic-microwave-background Doppler redshift direction, and the ±0.59 ps is the yearly change in the daily oscillation due to the Earth's velocity around the sun.

Photon energy, defined by the average centroid time difference (t_{E}=(tₙ−t₁)/(n−1)) for (n) peaks in the TDC spectrum, is not sidereal. This time defines the average time between voltage peaks in the tunneled wavepacket and is plotted in FIG. 3, showing that photon energy is not sidereal and only changes with temperature. The photon energy time shown in FIG. 3 is ((t₄−t₁)/3) because the November 2002 data have four peaks in each TDC spectrum. The temperature is taken every 96 seconds and ten data points are used to compute the formal mean and standard deviation temperature values shown. The November 2002 experiment was engineered to have four peaks in each TDC spectrum to test the wavepacket energy equation (t_{E}=(tₙ−t₁)/(n−1)) for (n>3) peaks in the TDC spectrum. The November 2002 experiment produced 4 peaks in each TDC spectrum by lowering the 9307 discriminator level.

The photon group velocity, defined using the peaking time given by Equation (1), is sidereal. Specifically, the peak Poynting vectors, defined as the number of counts under each peak, are sidereal. When the tunneling-photon propagation direction is into the cosmic-microwave-background Doppler redshift direction, there are the most counts under the first peak in the TDC spectrum and the least counts under the last peak. The first peak is shown in FIG. 4, with a centroid time of 45 ns and the last peak with a centroid time of 59 ns. As the tunneling direction rotates out of the redshift direction, the number of counts under the first peak decreases and the number of counts under the last peak increases.

For the 2002 data with three peaks in each TDC spectrum, the measured unequal spacing between the peaks is the bandlimit time (ΔΔτ=2[(t₂−t₁)−(t₃−t₂)]). The second and third peaks have the smallest separation between their centroid times because this experiment was engineered so that the highest energy wavepacket component would be near the wavepacket tail. The 2002 experiment was engineered to have the highest energy wavepacket component near the wavepacket tail in order to prove Peatross et. al. theory, which states that it does not mater if the highest energy component is near the wavefront or near the wavepacket tail. The 2002 experiment was operated with a minimum gain setting on both Amplifiers (catalog # 15-1113C shown in FIG. 1). The 2003 experiment used increased gain on the transmitting amplifier to zero the bandlimit time at the beginning of the RG flow.

As discussed above, the tunneling time, shown in FIG. 6, detects a direction in space that is equivalent to the cosmic-microwave-background Doppler redshift direction. The Doppler redshift is caused by the Earth's velocity relative to the cosmic-microwave-background rest frame. When the tunneling direction is opposite to the Earth's cosmic velocity the tunneling time is minimum.

Sidereal peaking time 2002 minimums are shown in FIG. 6. The April computed redshift direction time, at 25:03:43:00 (D:H:M:S) Pacific Daylight Time (PDT), is the time that tunneling is into the cosmic-microwave-background Doppler redshift direction on Apr. 25, 2002. The measured minimums in the peaking times are at the computed redshift times as shown in FIG. 6, thus proving the cosmic compass technology claimed in the previous cosmic compass patent by measuring the redshift direction movement. The computed redshift times, and therefore the minimum tunneling-time directions, are sidereal, in that they move around the clock, by about 4 minutes per day, as the Earth moves around the sun. The direction that is detected by the tunneling time minimums is always the same direction, and is equivalent to the cosmic-microwave-background Doppler redshift direction.

The difference in the counts under the first and third peaks is shown in FIG. 6 as delta counts. The standard deviation in the delta counts data is smaller than the peaking-time standard deviation, showing that the peaking-time sidereal-oscillation is caused by a redistribution in counts under the first and third peaks for the April data set. The large peaking-time standard deviation suggests that it is made large by a minimum-lower-bound as described by Kempf [[5] A. Kempf, “Fields over Unsharp Coordinates”, Phys. Rev. Lett. 85, 2873 (2000); hep-th/9905114 v2 2 Mar. 2000].

As discussed, the current invention is also directed to an apparatus and method for measuring the inverse fine structure constant and discovering the dilaton fundamental particle. In such an embodiment the apparatus is utilized to measure the tunneling photon phase velocity, which can then be used to determine the inverse fine structure constant. As the Earth's daily spin rotates the tunneling photon propagation direction into the cosmic microwave background Doppler redshift direction, and the group velocity approaches its maximum value, the photon bandlimit time (phase velocity) flows with the RG flow to a bulk spacetime caustic. That in turn measures the inverse fine structure constant, that in turn reveals the dilaton fundamental particle.

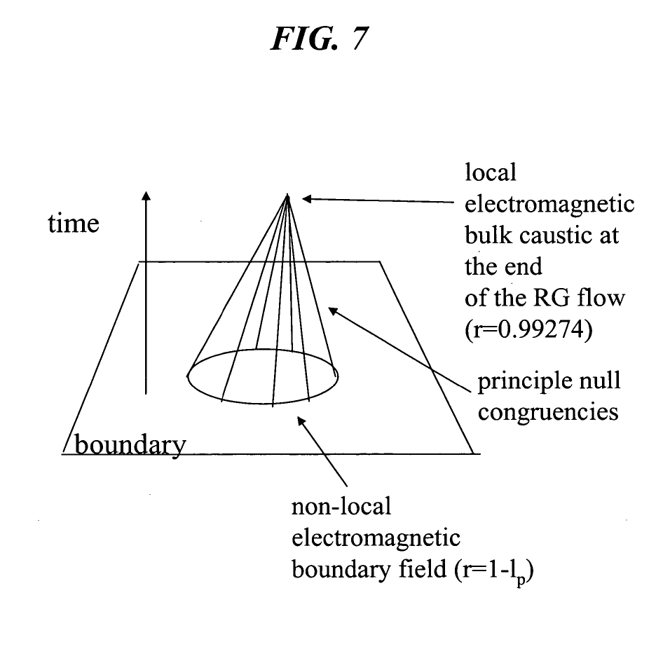

In principle the cosmic compass operates to reveal the dilaton fundamental particle because of the fundamental nature of photon interaction with the apparatus. Generally, photons do not self interact, and require optical coatings (the water mirror in the cosmic compass apparatus) to form quasi-photons that are bound states of photons and optical coatings. The quasi-photon energy bound to the water tanks is equal to the bandlimit energy (ΔE(B)=hωₘₐₓ−hωₘᵢₙ). The quasi-photon bound to the water tanks has less energy than a photon that is free to move on the “brane” that is the non-local electromagnetic 3-dimensional “brane” shown within one Planck length of the boundary in FIG. 7. The “brane” bound photon has less energy than a photon that is free to move in the “bulk” at (ΔE(N)) where N stands for Nyquist. As the self energies (E) and (ΔE(N)) are run backwards with the (RG) flow and become infinite on the boundary as the optical coating thickness (L) goes to zero, their difference (E−(ΔE(N))) remains finite. We substitute the air-gap length and optical coating thickness (L) for the electron radius in, Dresden's Equation (20). (M. Dresden, “Renormalization in Historical Perspective—The First Stage”, in Renormalization From Lorentz to Landau (and Beyond), L. Brown, Editor, Springer-Verlag, 1993, the disclosure of which is incorporated herein by reference.) We further define the radius (r²=ωₘᵢₙ/ωₘₐₓ) to make ΔE(N)=f(r) only, such that:
Lim(L→0)[E−ΔE(N)]=finite (2)
and Dresden's Equation equals:
   Lim(L→0)E[1−(1/2)(1+r²)/(1−r²)] (3)
where the time metric tensor is defined by:
   gₜₜ=(1+r²)/(1−r²)=(137.036 at the bulk caustic) (4)
and where the measured photon energy is defined by:
   E=4π [symbol] /(t₂₁+t₃₂)=2z,900 /[(1/ωₘᵢₙ)+(1/ωₘₐₓ)]) (5)
and where the measured bandlimit energy is defined by:
   ΔE(B)=2π [symbol] (|(1/t₂₁)−(1/t₃₂)|)= [symbol] ωₘₐₓ− [symbol] ωₘᵢₙ (6)

Because the coupling constant we measure is the magnetic monopole charge 137±4, that is the inverse fine structure constant 137.036 shown in FIG. 8, we are observing s-duality and dilaton physics as previously discussed. In the s-dual picture we define the Nyquist (N) energy scale ΔE(N),
ΔE(N)= [symbol] /ΔΔτ (7)
where (ΔΔτ) is the measured band limit time shown in FIGS. 5 and 8 and given by,
ΔΔτ=2(|t₂₁−t₃₂|)=4π[(1/ωₘᵢₙ)−(1/ωₘₐₓ)]) (8)
where (t₂₁=t₂−t₁), (t₃₂=t₃−t₂), and tₙ (n=1, 2, 3) are the centroids of Gaussian peaks in a 3-peak TDC analyzer spectrum like the spectrum drawing shown in FIG. 4.

Modern dilaton physics, as introduced by Duff supports description by the spacetime metric given by Equation (9), where the fifth dimension is the radial coordinate (r) into the (Anti de Sitter) AdS₅ bulk spacetime, the AdS₅ spacetime is the open ball AdS₄ space with radial coordinate (r<1) and Euclidean time (−∞<t<+∞), and the boundary CFT₄ is at (r=1−(Planck length)) and boundary distances are dimensionless. Under these conditions, the metric is given by the equation:
dS²=R²[gᵣᵣ(dr²+r²dΩ₃²)−gₜₜc²dt²+dΩ₅²] (9)
where R=1 on the boundary and in the U(R)=U(1) gauge (gₜₜ=(1+r²)/(1−r²)=137.036) is the magnetic monopole charge and the inverse fine structure constant, (gᵣᵣ=4(1−r²)⁻²) is the negative curvature and negative energy hyperbolic radial metric tensor that supports the dilaton microscopic “wormholes”, (dΩ₃²) is the metric on the 3-dimensional unit sphere (S³), and (dΩ₅²) is the metric on the 5-dimensional unit sphere (S⁵). Our Equation (9) is also given by Bousso's Equation (9.1) and by Susskind's Equation (2.1). See, e.g., R. Bousso, “The Holographic Principle”, Rev. Mod. Phys. 74 825 (2002); arXiv:hep-th/0203101 v2 29 Jun. 2002; and L. Susskind and E. Witten, “The Holographic Bound in Anti-deSitter Space”, arXiv:hep-th/9805114, 19 May 1998, the disclosures of which are incorporated herein by reference.

Changing Shannon entropy with RG flow in the ultraviolet limit is the von Neumann entropy corresponding to the bare coupling constant. In the infrared limit the measurable quantity at the maximum Shannon entropy is the fine structure constant (α=1/137.036). Fujikawa's Equation (4.5) is our bandlimit energy Equation (6), as described in Fujikawa, where 1/(|(1/t₂₁)−(1/t₃₂)|)=Δt_{c} in Fujikawa's notation. (K. Fujikawa, “Remarks an Shannon's Statistical Inference and the Second Law in Quantum Statistical Mechanics”, arXiv:cond-mat/0005496 v4 1 Apr. 2002, the disclosure of which is incorporated herein by reference.) Because our measurable quantity is the inverse fine structure constant, as opposed to the fine structure constant, the cosmic compass is capable of measuring the s-dual and magnetic monopole central charge. The presence of the s-duality turns on dilaton physics.

The cosmic compass apparatus measures three values of the time metric tensor and all three values equal 137.036, within their standard deviations, at the bulk caustic, as defined by:
gₜₜ(1)=(1/E)(8πΔE(N)) (10)
gₜₜ(2)=(E)(2/ΔE(B)) (11)
gₜₜ(3)=(16πΔE(N)/ΔE(B))^{1/2} (12)

Solving each measured gₜₜ value in terms of the others leads to the same Equation (13),
E²=4πΔE(B)ΔE(N) (13)

In the s-dual picture, as the bandlimit energy goes to zero, the Nyquist energy goes to infinity as shown by Equation (13). The energies in Equation (13) as measured by the cosmic compass apparatus are listed in the following Table 2, below.

TABLE 2
Measurements of the Time Metric Tensor by Cosmic Compass

| | 2:3:19 (D:H:M) | 2:4:18 (D:H:M) |
|---|---|---|
| | May 03 redshift | May 03 bulk |
| | direction time | caustic time |
| gₜₜ(1, 2, 3) | 158 ± 4 | 137 ± 4 |
| | | min. value |
| ΔE(B) (ergs) | (1.19 ± 0.05)E−20 | (1.37 ± 0.08)E−20 |
| E (ergs) | (9.420 ± 0.005)E−19 | (9.422 ± 0.007)E−19 |
| ΔE(N) (ergs) | (5.9 ± 0.1)E−18 | (5.1 ± 0.1)E−18 |
| | | min. value |
| Δ × (N) (cm) | — | 6.2 ± 0.2 |
| GΔE(N)Δ × (N)/c⁴ | — | (Planck length)² |

As previously, discussed, the quasi-photon bound to the water tanks has bandlimited energy (ΔE(B)), and this is less energy than (E) of a photon that is free to move in the laboratory on the “brane” and the “brane” bound photon with energy (E) has less energy than (ΔE(N)) of a “bulk” photon that is free to move in the “bulk” at the Nyquist energy scale. The minimum value of the time metric tensor (gₜₜ) is the inverse fine structure constant (137.036). The Nyquist sample spacing, Δx(N), equals the amount of space consumed by the microscopic “wormholes”. The Nyquist energy in geometric units, (G/c⁴)(ΔE(N)), times the Nyquist sample spacing, (Δx(N)), equals the Planck length squared. This measurement of the Planck length squared indicates that the dilaton is an internal component of the spacetime metric as introduced by Duff. The microscopic “wormhole” physics is described in further detail by C. Callan and J. Maldacena, “Brane Dynamics from the Born-Infeld Action”, Nuc. Phys. B 513 (1998) 198, the disclosure of which is incorporated herein by reference.

The RG flow is from an extended 3-dimensional “brane” (the electromagnetic field) within a Planck length of the boundary CFT₄ (4-dimensional Conformal Field Theory) to a local caustic in the bulk AdS₅ (5-dimensional Anti deSitter) spacetime as shown in FIG. 7, and described in further detail by V. Sahakian and R. Bousso (“Holography, a covariant c-function, and the geometry of the renormalization group”, Phys Rev D 62, 126011 (2000); and “The Holographic Principle”, Rev. Mod. Phys. 74 825 (2002)), the disclosures of which are incorporated herein by reference. The tunneling “superluminal” photon is a quasi-photon that stores energy in the tunnel barrier and is the extended electromagnetic object on the boundary CFT₄ at the beginning of the RG flow and is the local electromagnetic caustic in the bulk AdS₅ spacetime at the end of the RG flow.

In turn, the measured RG parameter equals the time metric tensor (gₜₜ). The measured metric tensor is equal to inverse fine structure constant and to the s-dual magnetic monopole charge at the end of the RG flow to the local electromagnetic caustic in the bulk AdS₄ space,
gₜₜ=(1+r²)/(1−r²)=137.036= [symbol] c/e² (14)
where (r²=ωₘᵢₙ/ωₘₐₓ) and (e) is the electric charge on the electron. The measured AdS₄ space radial coordinate is r=0.99274 at the bulk caustic at the end of the RG flow.

Very near the boundary CFT₄ the measured bandlimit time almost vanishes and the boundary UV Nyquist energy is equal to the Planck energy. The Nyquist energy (ΔE(N)= [symbol] /ΔΔτ) measures the energy scale of the RG flow. The energy scale decreases, from the Planck energy, almost on the UV boundary, to the Nyquist energy scale at the bulk IR caustic. At the bulk IR caustic at 2:4:18 (D:H:M) in May 2003, at the end of the RG flow, ΔE(N)=(5.1±0.1)E-18 ergs, the Nyquist sample spacing is (Δx(N)=cΔΔτ=6.2±0.2 cm), and the measured bandlimit time is (ΔΔτ=0.205±0.006 ns). The Nyquist energy scale in geometric units is (ΔE(N) [cm]=(G/c⁴)(ΔE(N))=4.21E-67 cm). Because (Δx=6.2 cm), we discover the following equation by inspection,

$$\begin{matrix}Δ x ( N ) [ cm ] = {l}_{{p}^{2}} / Δ E ( N ) [ cm ] \\ = ( Gℏ / {c}^{3} ) / [ ( G / {c}^{4} ) ( Δ E ( N ) ) ] \\ = cΔΔτ \\ = 6.2 [ cm ]\end{matrix} \qquad ( 15 )$$

where (l_{P}=√(G [symbol] /c³)=1.616E-33 cm) is the Planck length.

As the measured bandlimit time (ΔΔτ) flows with the RG from 0.0 to 0.2 ns, the measured RG parameter (gₜₜ=(1+r²)/(1−r²)) flows from almost infinity on the boundary CFT₄ at (r=1−l_{P}), down to the inverse fine structure constant 137.036 at r=0.99274 shown in FIG. 8. The May 2003 data also shows the photon phase velocity (bandlimit time) flow with the RG to the caustic at the inverse fine structure constant (gₜₜ=137.036). In this plot it is shown that the peaking time standard deviation (τₚ(std)) equals the bandlimit time at the electromagnetic caustic at the amplitude of about 0.2 ns. This data also detects the cosmic-microwave-background Doppler redshift direction at the end of the RG flow shown in FIG. 9. The data shows the measured peaking time minimum at the computed redshift time where the amplitude of the sidereal oscillation is about 0.2 ns. Again, the redistribution of counts exposes the sidereal physics.

Accordingly, the apparatus and method in accordance with the current invention, and as shown in FIGS. 8 and 9, demonstrate that the electromagnetic caustic is in the bulk at (r=√(ωₘᵢₙ/ωₘₐₓ)=0.99274) at the inverse fine structure constant (gₜₜ=(1+r²)/(1−r²)=137.036).

Where the bulk anti deSitter space connects to the compact 5-dimensional unit-sphere space, on the boundary CFT₄, is a Planck throat where the “brane” lives that acts like a wormhole throat for superluminal energy flow. Superluminal energy flow through the wormhole is only luminal inside the wormhole. The wormhole throat radius is the Planck length on the boundary electromagnetic “brane”. Understanding how these higher dimensional effects appear from the point of view of the laboratory requires decomposing the boundary space, into the disjoint union of two Planck scale spheres (S²∪S²) separated by the Nyquist sample spacing (S¹). The circle (S¹) connects the disjoint spheres in the higher dimensional Einstein space and through the Nyquist spacing in the boundary space. There are two paths between the two spheres (S²∪S²), one path through the boundary space and one path into one sphere (S²) and out the other sphere (S²). When the circle (S¹) is lined up along the cosmic microwave background Doppler redshift direction, the electromagnetic energy as defined above, falls into one sphere and comes out the other sphere, 6 cm or 9 cm, ahead of the path through the boundary space. The disjoint sphere (S²∪S²) is the same wormhole mouth (and throat). Luminal energy flow through the wormhole only appears superluminal in the laboratory, and therefore preserves the dominant energy condition for one-way “superluminal” electromagnetic energy flow. The measured photon energy, defined using the photon energy equation, is constant because photon energy always moves at the vacuum speed of light through the background dilaton “wormhole” spacetime. For a tunneling photon propagating into the cosmic microwave background Doppler redshift direction, the background spacetime contains a microscopic “wormhole” that consumes a Nyquist sample spacing length of space. The microscopic “wormhole” is a dilaton scalar particle.

Cosmic compass technology adds quasi-photon experiments to glueball experiments, so that now all of the standard-model massless bosons have a geometric experimental description. Glueballs are the large N limit as described in further detail by Maldacena (J. Maldacena, “The Large N Limit of Superconformal field theories and supergravity”, Adv. Theor. Math. Phys. 2 (1998) 231), the disclosure of which is incorporated herein by reference. Quasi photons are at (N=1) as measured above and are further described by C. Callan and J. Maldacena, “Brane Dynamics from the Born-Infeld Action”, Nuc. Phys. B 513 (1998) 198; the disclosure of which is incorporated herein by reference.

Accordingly, based on these theories it is possible to use the cosmic compass device described herein to measure the dilaton scalar particle. Including demonstrating that the negative energy density that is required to support the dilaton wormholes, E(dilaton)/m³, is equivalent to the positive “phantom” dark energy density, E(dark)/m³, required to produce the acceleration in the expansion rate of the universe, E(dark)/m³=6.7E-10 joules/m³ [8]. Negative dilaton energy density, E(dilaton)/m³, saturates the QI in the U(1) electromagnetic field and is developed in the reference to T. Roman, the disclosure of which is incorporated herein by reference. (T. Roman, “Some Thoughts on Energy Conditions and Wormholes”, gr-qc/0409090 v1 23 Sep. 2004, Eq. 6.) Roman's Equation (6) becomes our Equation (16).
E(dilaton)/unit volume=−(3N/32π²)ΔE(N)/(Δx(N))³ (16)
where N=1 in the small N limit and (N)=(Nyquist). The dilaton fundamental particle measured herein is negative energy excitations of the positive “phantom” dark energy field as described in S. Carroll, M. Hoffman, and M. Trodden, “Can the dark energy equation-of-state parameter w be less than −1?”, arXiv:astro-ph/0301273 v2 4 Feb. 2003, the disclosure of which is incorporated herein by reference. Saturation of the Ford-Roman QI by each tunneling photon is nature's cutoff that stabilizes “phantom” dark energy and stabilizes the negative energy and negative spacetime curvature of the dilaton fundamental particle. For the 2003 data set at 2:4:18 (D:H:M) on May 2003, ΔE(N)=5.1E-18 ergs and Δx(N)=6.2 cm and therefore E(dilaton)/cm³=(−2.0E-22 ergs/cm³)=(−2.0E-23 J/m³). Therefore, if each tunneling pulse contained 3.35E13 photons, then −E(dilaton)/m³=E(dark)/m³=(6.7E-10 J/m³). The required number of photons (3.35E13) times the photon energy (9.422E-19 ergs) equals 3.15E-5 ergs/pulse=3.15E-12 joules/pulse and because each pulse is 80 ns long, the average tunneled power per pulse is 39.4 micro-Watts/pulse. If this is made equal to the tunneled pulse power by increasing the transmitter amplifier gain, than the cosmic compass apparatus would be borrowing all of the available “phantom” dark energy. Said “phantom” energy being equal to 6.7E-10 joules/m³, the “phantom” dark energy required to cause the known accelerated expansion rate of the universe.

A tunneled power of 39.4 micro-Watts/pulse is within the amplifier gain and calorimetry capability of the cosmic compass apparatus. The apparatus captures all of the transmitted pulse energy in the receiving antenna cavity and measures the transmitted pulse energy and power with the receiving antenna. The cosmic compass apparatus can then be used to show that the measured pulse energy and power inside the receiving cavity contains the correct number of photons. The correct number of photons would produce the correct dilaton negative energy density inside each tunneled pulse. The correct pulse-excited “phantom” negative energy density within the quantum tunnel would be equal to the positive “phantom” dark energy density with the negative pressure required in all of space to cause the known accelerating expansion rate of the Universe.

As described above, “phantom” positive dark energy density is homogeneously distributed throughout space but the dilaton negative energy density inside the cosmic compass apparatus is the maximum non-homogenous distribution of the same dark energy field, the dilaton.

Although specific embodiments are disclosed herein, it is expected that persons skilled in the art can and will design alternative light velocity vector measurement systems that are within the scope of the following claims either literally or under the Doctrine of Equivalents.

### REFERENCES

[1] R. Y. Chiao, “Tunneling Times and Superluminality: a Tutorial”, arXiv:quant-ph/9811019, 7 Nov. 1998.
[2] C. Will, “Clock synchronization and isotropy of the one-way speed of light”, Phys. Rev. D 45, 403 (1992).
[3] J. Rembielinski, “Superluminal Phenomena and the Quantum Preferred Frame”, quant-ph/0010026, 6 Oct. 2000 At LANL.
[4] K. Hagiwara et. al., Phys Rev D 66, 010001 (2002), Sec. 22.3.1 the dipole, see http://pdg.lbl.gov/pdg_{—}2002.html D. Fixsen et. al., Astrophys. J. 473, 576 (1996).
[5] A. Kempf, “Fields over Unsharp Coordinates”, Phys. Rev. Lett. 85, 2873 (2000); hep-th/9905114 v2 2 Mar. 2000.
[6] C. Callan and J. Maldacena, “Brane Dynamics from the Born-Infeld Action”, Nuc. Phys. B 513 (1998) 198; hep-th/9708147.
[7] M. Duff, “A Layman's Guide to M-Theory”, arXiv:hep-th/9805177 v3 2 Jul. 1998.
[8] J. Cramer, ““Outlawing” Wormholes and Warp Drives”, Analog, science fiction and science fact, May 2005.
[9] T. Roman, “Some Thoughts on Energy Conditions and Wormholes”, gr-qc/0409090 v1 23 Sep. 2004.
[10] H. Reichenbach, The Direction of time, M. Reichenbach Editor, Dover Publications, Mineola N.Y. 1999.
[11] K. Fujikawa, “Remarks an Shannon's Statistical Inference and the Second Law in Quantum Statistical Mechanics”, arXiv:cond-mat/0005496 v4 1 Apr. 2002.
[12] J. Peatross, S. A. Glasgow, and M. Ware, “Average Energy Flow of Optical Pulses in Dispersive Media”, Phys. Rev. Lett. 84, 2370 (2000).
[13] M. Dresden, “Renormalization in Historical Perspective—The First Stage”, in Renormalization From Lorentz to Landau (and Beyond), L. Brown, Editor, Springer-Verlag, 1993.
[14] R. Bousso, “The Holographic Principle”, Rev. Mod. Phys. 74 825 (2002); arXiv:hep-th/0203101 v2 29 Jun. 2002.
[15] L. Susskind and E. Witten, “The Holographic Bound in Anti-deSitter Space”, arXiv:hep-th/9805114, 19 May 1998.
[16] V. Sahakian, “Holography, a covariant c-function, and the geometry of the renormalization group”, Phys Rev D 62, 126011 (2000).
[17] J. Maldacena, “The Large N Limit of Superconformal field theories and supergravity”, Adv. Theor. Math. Phys. 2 (1998) 231, arXiv:hep-th/9711200 v3, 22 Jan. 1998.
[18] S. Carroll, M. Hoffman, and M. Trodden, “Can the dark energy equation-of-state parameter w be less than −1?”, arXiv:astro-ph/0301273 v2 4 Feb. 2003.

1. A cosmic compass device for measuring the sidereal tunneling time of a wavepacket comprising:
a transmission source for generating a wavepacket;
a signal controller for generating a signal pulse;
a signal receiver for receiving the signal pulse;
a quantum tunnel device comprising a quantum barrier defining a transmission distance, said quantum tunnel device being in signal communication with the transmission source, the signal controller, and the receiver such that the wavepacket is transmitted to the barrier and across the transmission distance to the receiver causing sidereal or one-way “superluminal” group velocities;
a monitor in signal communication with the receiver for determining the centroid time for each of a plurality wavepacket peaks; and
an analyzer for computing the sidereal phase velocity of light from the measured centroid times and determining the inverse fine structure constant therefrom.

2. The cosmic compass device as described in claim 1, wherein the quantum barrier comprises a pair of transmission barriers positioned parallel to each other and separated by an air gap having a length.

3. The cosmic compass device as described in claim 2, wherein the pair of transmission barriers are tanks defining an internal volume capable of holding a liquid.

4. The cosmic compass device as described in claim 3, wherein the liquid is water.

5. The cosmic compass device as described in claim 2, wherein the length of the air gap can be adjusted such that the length of the air gap enhances “superluminal” wavepacket transmission.

6. The cosmic compass device as described in claim 1, wherein the transmitter comprises a pulse transmitter in signal communication with a transmission antenna.

7. The cosmic compass device as described in claim 6, wherein the antenna is a five element folded-dipole Yagi antenna.

8. The cosmic compass device as described in claim 1, wherein the transmitter further comprises a bandlimiting wavelength selector such that only desired radio wavelengths are transmitted.

9. The cosmic compass device as described in claim 1, wherein the receiver comprises a radio amplifier in signal communication with a receiver antenna.

10. The cosmic compass device as described in claim 9, wherein the antenna is a five element folded-dipole Yagi antenna.

11. The cosmic compass device as described in claim 1, wherein the apparatus is designed as a teaching tool for demonstrating a physical principle selected from the list consisting of dual bulk-AdS₅ space-time electromagnetic caustic physics, boundary electromagnetic Planck scale physics, and dilaton physics in string theory.

12. The cosmic compass device as described in claim 1, wherein the apparatus is arranged such that the tunneling wavepacket propagates into the cosmic microwave background Doppler redshift direction such that a microscopic wormhole is created that consumes a Nyquist sample spacing length of space, such that the properties of the dilaton scalar particle can be measured.

13. The cosmic compass device as described in claim 1, wherein the apparatus is further designed to monitor the energy of the signal pulse.

14. The cosmic compass device as described in claim 13, wherein the analyzer is further designed to determine the number of photons in each signal pulse from the measurement of the energy of the signal pulse.

15. The cosmic compass device as described in claim 14, wherein the analyzer is further designed such that a dilaton negative energy density can be calculated from the measurement of the number of photons.

16. The cosmic compass device as described in claim 15, wherein the power of each signal pulse may be adjusted.

17. The cosmic compass as described in claim 16, wherein the power of the signal pulse is increased such that the dilaton negative energy measures the “phantom” positive dark energy required to cause the known accelerated expansion rate of the universe.

18. The cosmic compass device as described in claim 15, wherein the measurement of the dilaton negative energy density provides a measurement of the “phantom” positive dark energy.

19. The cosmic compass device as described in claim 15, wherein the measurement of the “phantom” dark energy provides a measurement of the positive dark energy density with negative pressure.

20. The cosmic compass device as described in claim 18, wherein the apparatus is designed as a teaching tool to demonstrate that the excited “phantom” dark energy density is negative energy density that supports microscopic dilaton “wormholes”.

21. The cosmic compass device as described in claim 1, wherein the apparatus is designed as a teaching tool to demonstrate how a “superluminal” average energy flow is luminal through the inside of a microscopic dilaton “wormhole”.

22. The cosmic compass device as described in claim 13, wherein the apparatus is designed as a teaching tool to demonstrate how the signal pulse energy is defined by the Nyquist energy density.

23. The cosmic compass device as described in claim 22, wherein the apparatus is designed as a teaching tool to demonstrate that the Nyquist energy density saturates the Ford-Roman QI.

24. The cosmic compass device as described in claim 1, wherein the apparatus is designed as a teaching tool to demonstrate that the measured inverse fine structure constant is s-dual to a fine structure constant that would have been the measurable quantity in the infrared limit at the maximum Shannon entropy at the end of the RG flow and therefore identifies dilaton physics.

25. The cosmic compass device as described in claim 1, wherein the apparatus is designed as a teaching tool to demonstrate that the inverse fine structure constant is the s-dual magnetic monopole central charge.

26. The cosmic compass device as described in claim 25, wherein the apparatus is designed as a teaching tool to demonstrate that the s-duality turns on dilaton physics.

27. The cosmic compass device as described in claim 26, wherein the apparatus is designed as a teaching tool to demonstrate that dilaton physics is described by a spacetime metric.

28. The cosmic compass device as described in claim 27, wherein the apparatus is designed as a teaching tool to demonstrate that the spacetime metric contains a time metric tensor that flows with the RG flow to the magnetic monopole central charge.

29. The cosmic compass device as described in claim 27, wherein the apparatus is designed as a teaching tool to demonstrate that the spacetime metric contains a hyperbolic radial metric tensor that describes negative space curvature.

30. The cosmic compass device as described in claim 29, wherein the apparatus is designed as a teaching tool to demonstrate that the negative space curvature is negative energy that supports dilaton microscopic “wormholes”.

31. The cosmic compass device as described in claim 23, wherein the apparatus is designed as a teaching tool to demonstrate that the saturated QI indicates 100% excitation of the “phantom” dark energy inside the apparatus.

32. The cosmic compass device as described in claim 23, wherein the apparatus is designed as a teaching tool to demonstrate that the saturated QI is nature's cutoff that stabilizes “phantom” dark energy and stabilizes the negative energy and negative spacetime curvature of the dilaton fundamental particle.

33. A method for measuring the inverse fine structure constant utilizing a cosmic compass as described in claim 1 to measure the centroid times and a sidereal photon phase velocity.
